(19) United States
(12) Patent Application Publication
(10) Pub. No.: US 2025/0240701 A1
(43) Pub. Date: Jul. 24, 2025

(54) MULTICAST PROXY FOR ISOLATED NETWORK

(71) Applicant: Lenovo Enterprise Solutions (Singapore) Pte. Ltd., New Tech Park (SG)

(72) Inventors: Caihong Zhang, Shanghai (CN); Fred Allison Bower, III, Durham, NC (US); Jiang Chen, Shanghai (CN)

(21) Appl. No.: 18/952,749

(22) Filed: Nov. 19, 2024

(30) Foreign Application Priority Data
Jan. 23, 2024 (WO) PCT/CN2024/073592

(51) Int. Cl. H04W 40/24; H04L 47/80

(52) U.S. Cl. CPC H04W 40/246; H04L 47/806

(57) ABSTRACT

A method for multicast discovery requests to an isolated network includes establishing a socket tunnel between a client proxy running on a computing device in a first subnet and a server proxy running on a server on a second subnet and receiving a discovery request from the server proxy. The discovery request is directed to first subnet computing devices on the first subnet and/or services provided by the first subnet computing devices and the discovery request is transmitted over the socket tunnel. The method includes transmitting a discovery reply to the server proxy. The discovery reply includes discovery information responsive to the discovery request received from the server proxy where the discovery information is regarding the first subnet computing devices.

### CROSS-REFERENCE TO RELATED APPLICATIONS

This patent application claims priority to China PCT Application No. PCT/CN2024/073592 filed on Jan. 23, 2024 for Zhang et al., the entire contents of which are incorporated herein by reference for all purposes.

### FIELD

The subject matter disclosed herein relates to multicast discovery requests and more particularly relates to multicast discovery requests to an isolated network.

### BACKGROUND

Networks typically use discovery requests to identify computing devices to communicate with, that provide services, etc. The computing devices that receive a discovery request typically reply with identifying information, descriptions of services provided by the computing devices, and the like. Discovery protocols are used to formulate discovery requests and responses. In some cases, multicast is used to deliver discovery requests. Typically, however, multicast discovery requests are limited to computing devices on a common subnet.

### BRIEF SUMMARY

A method for multicast discovery requests to an isolated network is disclosed. An apparatus and computer program product also perform the functions of the method. The method includes establishing a socket tunnel between a client proxy running on a computing device in a first subnet and a server proxy running on a server on a second subnet and receiving a discovery request from the server proxy. The discovery request is directed to first subnet computing devices on the first subnet and/or services provided by the first subnet computing devices and the discovery request is transmitted over the socket tunnel. The method includes transmitting a discovery reply to the server proxy. The discovery reply includes discovery information responsive to a discovery request received from the server proxy where the discovery information is regarding the first subnet computing devices.

An apparatus for multicast discovery requests to an isolated network includes a processor and non-transitory computer readable storage media storing code. The code is executable by the processor to perform operations that include establishing a socket tunnel between a client proxy running on a computing device in a first subnet and a server proxy running on a server on a second subnet and receiving a discovery request from the server proxy. The discovery request is directed to first subnet computing devices on the first subnet and/or services provided by the first subnet computing devices and the discovery request transmitted over the socket tunnel. The operations include transmitting a discovery reply to the server proxy. The discovery reply includes discovery information responsive to a discovery request received from the server proxy where the discovery information is regarding the first subnet computing devices.

A program product for multicast discovery requests to an isolated network includes a non-transitory computer readable storage medium storing code. The code is configured to be executable by a processor to perform operations that include establishing a socket tunnel between a client proxy running on a computing device in a first subnet and a server proxy running on a server on a second subnet and receiving a discovery request from the server proxy. The discovery request is directed to first subnet computing devices on the first subnet and/or services provided by the first subnet computing devices and the discovery request transmitted over the socket tunnel. The operations include transmitting a discovery reply to the server proxy. The discovery reply includes discovery information responsive to a discovery request received from the server proxy where the discovery information is regarding the first subnet computing devices.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating a system for multicast discovery requests to an isolated network, according to various embodiments;

FIG. 1B is a schematic block diagram illustrating another system for multicast discovery requests to an isolated network, according to various embodiments;

FIG. 2 a tag table for tags associated with applications seeking discovery and a discovery cache table, according to various embodiments;

FIG. 3 is a schematic block diagram illustrating an apparatus for multicast discovery requests to an isolated network, according to various embodiments;

FIG. 4 is a schematic block diagram illustrating another apparatus for multicast discovery requests to an isolated network, according to various embodiments;

FIG. 5 is a schematic block diagram illustrating an apparatus for a server proxy for multicast discovery requests to an isolated network, according to various embodiments;

FIG. 6 is a schematic flow chart diagram illustrating a method for multicast discovery requests to an isolated network, according to various embodiments; and

FIG. 7 is a schematic flow chart diagram illustrating another method for multicast discovery requests to an isolated network, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for multicast discovery requests to an isolated network is disclosed. An apparatus and computer program product also perform the functions of the method. The method includes establishing a socket tunnel between a client proxy running on a computing device in a first subnet and a server proxy running on a server on a second subnet and receiving a discovery request from the server proxy. The discovery request is directed to first subnet computing devices on the first subnet and/or services provided by the first subnet computing devices and the discovery request is transmitted over the socket tunnel. The method includes transmitting a discovery reply to the server proxy. The discovery reply includes discovery information responsive to a discovery request received from the server proxy where the discovery information is regarding the first subnet computing devices.

In some embodiments, the method includes, in response to receiving the discovery request, reading discovery cache accessible to the client proxy to identify the discovery information regarding the first subnet computing devices. Transmitting the discovery reply to the server proxy is in response to identifying that the discovery information is present in the discovery cache. In further embodiments, the method includes, in response to the discovery information not being present on the discovery cache, transmitting the discovery request to the first subnet computing devices, receiving discovery information from at least a portion of the first subnet computing devices, and storing the received discovery information in the discovery cache. In other embodiments, the discovery request complies with a multicast discovery request protocol and/or the client proxy transmits the discovery request via a multicast port. In other embodiments, a header of the discovery request includes an application tag. The application tag corresponds to an application initiating the discovery request and transmitting the discovery request to the server proxy. In other embodiments, the method includes adding the application tag to the discovery reply prior to transmission of the discovery reply where the server proxy transmits the discovery reply to the application based on the application tag.

In some embodiments, the first subnet computing devices include the computing device with the client proxy. In other embodiments, the server is a management server and one or more of the first subnet computing devices include a management controller in communication with the management server. In other embodiments, the client proxy executes on the management controller of the computing device with the client proxy. In some embodiments, code for execution of the client proxy is installed on two or more of the first subnet computing devices and the code for the client proxy is executed on a managing computing device of the first subnet computing devices selected to manage discovery requests. In other embodiments, the discovery request and the discovery reply are formulated using a multicast discovery protocol includes simple service discovery protocol (“SSDP”) or service location protocol (“SLP”). In other embodiments, the socket tunnel uses a WebSocket, a transmission control protocol (“TCP”) socket, hypertext transfer protocol (“HTTP”) socket, hypertext transfer protocol secure (“HTTPS”) socket, a user datagram protocol (“UDP”) socket, and/or a Quick UDP Internet Connections (“QUIC”) socket.

An apparatus for multicast discovery requests to an isolated network includes a processor and non-transitory computer readable storage media storing code. The code is executable by the processor to perform operations that include establishing a socket tunnel between a client proxy running on a computing device in a first subnet and a server proxy running on a server on a second subnet and receiving a discovery request from the server proxy. The discovery request is directed to first subnet computing devices on the first subnet and/or services provided by the first subnet computing devices and the discovery request transmitted over the socket tunnel. The operations include transmitting a discovery reply to the server proxy. The discovery reply includes discovery information responsive to a discovery request received from the server proxy where the discovery information is regarding the first subnet computing devices.

In some embodiments, the operations include, in response to receiving the discovery request, reading discovery cache accessible to the client proxy to identify the discovery information regarding the first subnet computing devices. Transmitting the discovery reply to the server proxy is in response to identifying that the discovery information is present in the discovery cache. In further embodiments, the operations include, in response to the discovery information not being present on the discovery cache, transmitting the discovery request to the first subnet computing devices, receiving discovery information from at least a portion of the first subnet computing devices, and storing the received discovery information in the discovery cache. In further embodiments, a header of the discovery request includes an application tag. The application tag corresponds to an application initiating the discovery request and transmitting the discovery request to the server proxy and the operations include adding the application tag to the discovery reply prior to transmission of the discovery reply. The server proxy transmits the discovery reply to the application based on the application tag.

In some embodiments, the server is a management server and one or more of the first subnet computing devices include a management controller in communication with the management server and the client proxy executes on the management controller of the computing device with the client proxy. In other embodiments, code for execution of the client proxy is installed on two or more of the first subnet computing devices and the code for the client proxy is executed on a managing computing device of the first subnet computing devices selected to manage discovery requests. In other embodiments, the discovery request and the discovery reply are formulated using a multicast discovery protocol includes one of simple service discovery protocol (“SSDP”) and service location protocol (“SLP”). In other embodiments, the socket tunnel uses a WebSocket, a transmission control protocol (“TCP”) socket, hypertext transfer protocol (“HTTP”) socket, hypertext transfer protocol secure (“HTTPS”) socket, a user datagram protocol (“UDP”) socket, and/or a Quick UDP Internet Connections (“QUIC”) socket.

A program product for multicast discovery requests to an isolated network includes a non-transitory computer readable storage medium storing code. The code is configured to be executable by a processor to perform operations that include establishing a socket tunnel between a client proxy running on a computing device in a first subnet and a server proxy running on a server on a second subnet and receiving a discovery request from the server proxy. The discovery request is directed to first subnet computing devices on the first subnet and/or services provided by the first subnet computing devices and the discovery request transmitted over the socket tunnel. The operations include transmitting a discovery reply to the server proxy. The discovery reply includes discovery information responsive to a discovery request received from the server proxy where the discovery information is regarding the first subnet computing devices.

In some embodiments, the operations include, in response to receiving the discovery request, reading discovery cache accessible to the client proxy to identify the discovery information regarding the first subnet computing devices. Transmitting the discovery reply to the server proxy is in response to identifying that the discovery information is present in the discovery cache. In further embodiments, the operations include, in response to the discovery information not being present on the discovery cache, transmitting the discovery request to the first subnet computing devices, receiving discovery information from at least a portion of the first subnet computing devices, and storing the received discovery information in the discovery cache. In other embodiments, a header of the discovery request includes an application tag where the application tag corresponds to an application initiating the discovery request and transmitting the discovery request to the server proxy and the operations further include adding the application tag to the discovery reply prior to transmission of the discovery reply. The server proxy transmits the discovery reply to the application based on the application tag.

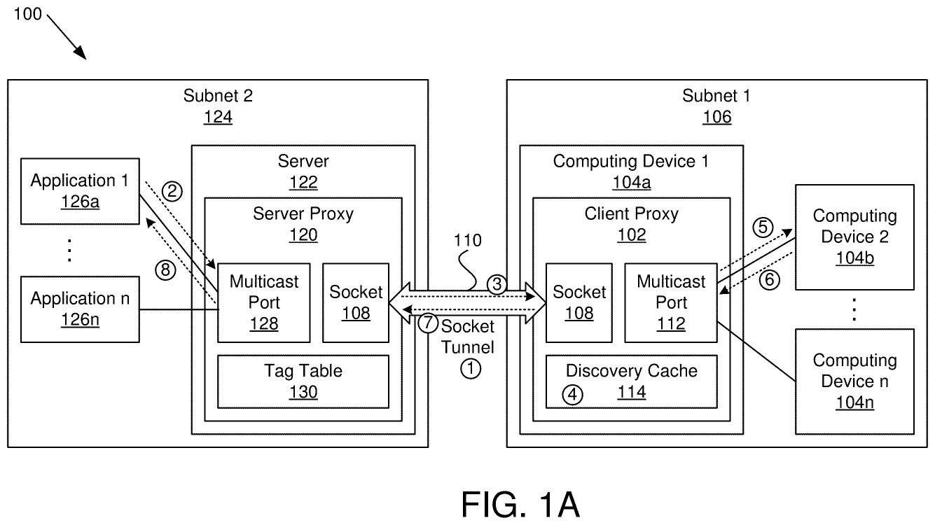

FIG. 1A is a schematic block diagram illustrating a system 100 for multicast discovery requests to an isolated network, according to various embodiments. The system 100 includes a client proxy 102 in a first computing device 104a of a first subnet 106 (e.g., subnet 1 106). The client proxy 102 includes a socket 108 connected over a socket tunnel 110 to a socket 108 of a server proxy 120 of a server 122 on a second subnet 124. The server proxy 120 and the client proxy 102 communicate over the socket tunnel 110 for multicast discovery messages sent from applications 126a-n (collectively or generically “126”) on the second subnet 124 to computing devices 104a-n (collectively or generically “104”) on the first subnet 106.

Typical multicast discovery messages are limited to the subnet where the applications 126 reside (e.g., the second subnet 124). However, there are often situations where discovery from one applications 126 on one subnet, such as a subnet of a cloud service, is required to identify computing devices 104 on another subnet, such as a subnet where edge computing devices are located, for example a subnet where services are provided by the computing devices 104 that are sought by the applications 126. Computing devices 104 on the first subnet 106, for example, may be edge devices managed by a cloud-based server 122, which is a management server. The edge devices (e.g., computing devices 104) may be able to connect to devices on the cloud subnet (e.g., the second subnet 124), but the server 122 and other applications 126 used by the server 122 are unable to penetrate a firewall and/or gateway of a subnet, such as the first subnet 106, with the computing devices 104 due to security concerns. However, the applications 126 and/or the server 122 need to discover the computing devices 104 to provide services to the applications 126.

Often discovery is done via multicast where a multicast sender sends out a message to a router that supports multicast forwarding, which then sends the message other routers that supports multicast forwarding, and eventually the multicast message arrives at numerous devices that are to receive the multicast message. Some multicast protocols are able to be routed between different internet protocol (“IP”) subnets. The solutions are often complicated and require pre-programming of the routers so that traffic is transmitted to all endpoints even when not needed. The multicast protocols are often complicated and require explicit programming of the routers and often result in unwanted network traffic.

Multicast discovery protocols, such as simple service discovery protocol (“SSDP”) and service location protocol (“SLP”) are limited to a single subnet. However, the embodiments described herein provide a way to use SSDP, SLP, and other multicast discovery protocols across subnets through the use of proxies (e.g., server proxy 120 and client proxy 102) connected over a socket tunnel 110.

A socket tunnel 110 is established between the client proxy 102 running on a computing device (e.g., first computing device 104a) in the first subnet 106 and the server proxy 120 running on the server 122 on a second subnet 124. The socket tunnel 110, in some embodiments, is a WebSocket, which is a computer communications protocol that provides simultaneous two-way communication channels over a single transmission control protocol (“TCP”) connection. In other embodiments, the socket tunnel 110 uses other socket protocols, such as secure socket layer (“SSL”) or transport layer security (“TLS”), both of which are cryptographic protocols that encrypt data and authenticate a connection when moving data across a public network. SSL and TLS may also be used with hypertext transfer protocol (“HTTP”), hypertext transfer protocol secure (“HTTPS”) so that the socket tunnel 110, in some embodiments, is a HTTPS connection. In other embodiments, the socket tunnel 110 uses the user datagram protocol (“UDP”)-based Quick UDP Internet Connections (“QUIC”) protocol or other UDP-based connection protocol. In other embodiments, other encryption layer encapsulation protocols may be used for the socket tunnel 110 that are capable of encapsulating a webcast discovery request or reply for transport from one subnet to another subnet.

The first subnet 106 and the second subnet 124 communicate over a computer network so that the socket tunnel 110 is over the computer network. In some embodiments, the computer network includes at least a portion that is a public network, such as the Internet. In some embodiments, the computer network includes a portion that is a private network. The computer network may include a LAN, a WAN, a fiber optic network, a wireless connection, a cellular network, or other network known to those of skill in the art. In some embodiments, the computer network includes two or more networks.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The client proxy 102 is depicted on a first computing device 104a, which is in communication with other computing devices 104 (e.g., computing devices 2-n 104b-n) over a computer network using the first subnet 106. In some embodiments, the first subnet 106 is separated from the computer network of the socket tunnel 110 by a firewall and/or gateway. While the first computing device 104a is depicted with the client proxy 102, in other embodiments, each of the computing devices 104 include a client proxy 102 with one client proxy 102 being active or being a master client proxy 102 while the other client proxies 102 are either inactive or allow the client proxy 102 serving as the master to communicate with the other computing devices 104b-n. Selection of computing device 1 104a is arbitrary in this scenario. In some embodiments, the client proxy 102 executes on another device that is not part of discovery rather than one of the computing devices 104a-n that are targets of a multicast discovery request.

In some embodiments, the computing devices 104 are grouped together and communicate with each other so that a discovery request coming to the client proxy 102 in one computing device (e.g., computing device 1 104a) may be relayed to the other computing devices (e.g., computing devices 2-n 104b-n). In some embodiments, an algorithm selects a lead computing device 104 with an active client proxy 102. In other embodiments, a system administrator selects a lead computing device 104. In other embodiments, which computing device 104 is the lead computing device 104 switches from time to time.

In some embodiments, the grouping of computing devices 104 is called a “federation.” In some embodiments, the grouping includes all computing devices 104 in a subnet (e.g., the first subnet 106). In other embodiments, computing devices 104 grouped in a federation include a common characteristic, such as all being of a same device type. In other embodiments, the computing devices 104 grouped in the federation share a common trait in the service(s) that the computing devices 104 provide. One of skill in the art will recognize other ways to group computing devices 104 in a subnet.

The computing devices 104, in various embodiments, may be a rack-mounted server, a non-volatile storage device, a power supply, a switch, a printer, or other computing device with a processor and that is capable of providing some type of service to an application 126 running on the second subnet 124 and/or is managed by the server 122, which may be a management server. In some embodiments, the computing device 104 is a desktop computer, a workstation, a blade server, a mainframe computer, a tablet computer, a smart appliance, a smartphone, or the like. The computing device 104 is any device that is available for multicast discovery.

The client proxy 102 serves as an endpoint for the socket tunnel 110 at a socket 108 and receives a multicast discovery request through the socket tunnel 110. The client proxy 102, in some embodiments, includes a multicast port 112 configured to multicast a discovery request to the other computing devices 104b-n on the first subnet 106. In other embodiments, the client proxy 102 transmits the multicast discovery request over a different port of the first computing device 104a.

In some embodiments, the client proxy 102 includes discovery cache 114 configured to store discovery information from the computing devices 104. While the discovery cache 114 is depicted in the client proxy 102, in other embodiments, the discovery cache 114 is located elsewhere and the client proxy 102 has access to the discovery cache 114. In some embodiments, the discovery cache 114 is located in cache within the first computing device 104a. In other embodiments, the discovery cache 114 is located outside of the first computing device 104a.

The discovery cache 114 serves to store discovery information from various computing devices 104 that is sent in response to the client proxy 102 transmitting the multicast discovery request to the computing devices 104. The discovery information includes information used to identify a computing device 104 and/or capabilities of the computing device 104. In some examples, the discovery information includes information such as a media access control (“MAC”) address, an internet protocol (“IP”) address, port numbers, a network identifier (“ID”), a serial number, and the like. In other embodiments, the discovery information includes information about a service provided by the computing device 104, such as an available storage capacity, execution capability on a graphical processing unit (“GPU”), accelerator. One of skill in the art will recognize other information to be included in discovery information includes in a discovery response transmitted in response to a discovery request.

The server proxy 120 is also connected to the socket tunnel 110 via a socket 108. The socket 108 in the server proxy 120 and in the client proxy 102, in some embodiments, is a software structure within a network node that serves as an endpoint to the socket tunnel 110 for sending and receiving data across the socket tunnel 110. In some embodiments, each socket 108 has a structure and properties defined by an application programming interface (“API”) for the applicable networking architecture. In some embodiments, the sockets 108 are created during the time that the socket tunnel 110 is in place. In some embodiments, the sockets 108 are internet sockets and are externally identified to other hosts by a socket address, which may include a transport protocol, an IP address, and a port number.

The server proxy also includes, in some embodiments, a multicast port 128 configured to receive multicast discovery requests from applications 126. In other embodiments, the server proxy 120 receives multicast discovery requests over another port. In some embodiments, the server proxy 120 includes a tag table 130 configured to correlate each of the applications 126a-n to a tag, which is an identifier that is formatted to be transmitted with a multicast discovery request. In some embodiments, the tags are inserted in a header of a multicast discovery request. In other embodiments, the tags are formatted to be attached to a multicast discovery request in another way. The tags are used to identify in the multicast discovery requests which application 126 send the request, and also to be included with a discovery reply to know where the server proxy 120 can send the discovery reply.

The server proxy 120, in some embodiments, is within a server 122. In some embodiments, the server 122 is a management server and manages the computing devices 104 in some capacity. In some examples, the computing devices 104 are part of an edge computing environment that does not include an on-site management server, and are instead managed by a management server 122 in a cloud computing environment (e.g., the second subnet 124). In some embodiments, the applications 126 support the server 122 and provide information to the server 122 and/or system administrator regarding the computing devices. While the server proxy 120 is depicted in a server 122, in other embodiments, server proxy 120 executes on another server or computing device that is not involved in management of the computing devices 104. In the embodiments, the server 122 may be separate from the device executing the server proxy 120.

The second subnet 124 includes a plurality of applications 126 capable of requesting discovery regarding computing devices 104 of the first subnet 106. In some embodiments, the applications 126 provide information to the server 122 for managing the computing devices 104. In some embodiments, the applications 126 are used by a customer to manage the computing devices 104 and/or receive information from the computing devices 104. In some illustrative examples, a petroleum company owns the computing devices 104, which are edge devices in a closet of a gas station and the applications 126 interact with the computing devices 104 to assist in running the gas station. In other embodiments, the applications 126 are part of a cloud computing environment and are running on virtual machines that provide cloud computing services for one or more customers and the computing devices 104 provide services to the applications 126, such as providing analytics, providing data from a process, providing extra computing capacity, providing a library of computing services, etc.

In illustrative examples, a first step (indicated by a “1” in a circle) in multicast discovery of computing devices 104 in an isolated network includes establishing a socket tunnel 110 between a client proxy 102 running on a computing device (computing device 1 104) in a first subnet 106 and a server proxy 120 running on a server 122 on a second subnet 124. Once the socket tunnel 110 is established, the second step (“2” in a circle) is an application (application 1 126a) transmits a multicast discovery request. The server proxy 120 monitors for multicast discovery requests and receives the multicast discovery request. The server proxy 120 attaches a tag to the multicast discovery request corresponding to the application 126 transmitting the request (e.g., application 1 126a).

The third step is for the server proxy 120 to transmit the multicast discovery request to the client proxy 104a over the socket tunnel 110. The socket tunnel 110 provides a way for the multicast discovery request to traverse from the second subnet 124 to the first subnet 106. Beneficially, the application (e.g., 126a) sending the multicast discovery request does not have to be aware that the computing devices 104 are on another subnet so that standard multicast discovery protocols may be used. Typical multicast discovery protocols include simple service discovery protocol (“SSDP”) and service location protocol (“SLP”). Other multicast discovery protocols may also be used, including those currently in use and other multicast discovery protocols in the future. Various socket tunnel protocols may be used for different multicast discovery protocols.

Once the client proxy 102 receives the multicast discovery request, in step 4 the client proxy 102 checks the discovery cache 114 for discovery information regarding the computing devices 104. If the discovery cache 114 has discovery information for the computing devices 104, the client proxy 102 formulates a discovery reply that includes the discovery information about the computing devices 104 and the tag received with the multicast discovery request and transmits the discovery reply to the server proxy 120 (step 7).

If the client proxy 102 determines that there is no discovery information or insufficient discovery information in the discovery cache 114, the client proxy 102 (step 5) transmits the multicast discovery request to the computing devices 104. In step 6, the computing devices 104 transmit discovery information to the client proxy 102 that is responsive to the multicast discovery request. Once the client proxy 102 has received the discovery information from the computing devices 104, which may also include discovery information from the first computing device 104a, the client proxy 102 stores the discovery information in the discovery cache 114 and in step 7 formulates a discovery reply that includes the discovery information received from the computing devices 104 and the tag received with the multicast discovery request and transmits the discovery reply to the server proxy 120.

In step 8 the server proxy 120 transmits the discovery reply to the application 126 that sent the multicast discovery request (e.g., application 1 126a). Note that another application 126, such as application 2 126b, may request information about different services so that a multicast discovery request from application 2 126b may request different discovery information and/or may request information from a subset of the computing devices 104 on the first subnet 106 or from different computing devices on a different subnet.

FIG. 1B is a schematic block diagram illustrating another system 101 for multicast discovery requests to an isolated network, according to various embodiments. In the system 101 of FIG. 1B, each computing device 104a-n includes a management controller 132a-n (collectively or generically “132”) in communication with the server 122 of the second subnet 124, which is a management server 122. In some embodiments, the management server 122 communicates with the management controllers 132 over a management network (not shown). In some embodiments, the socket tunnel 110 is over the management network. Again, while the discovery cache 114 is depicted in the client proxy 102, in some embodiments, the discovery cache 114 is located elsewhere, such as in cache in or available to the first management controller 132a. The numbered circles and corresponding arrows in FIG. 1A depicting a process flow for multicast discovery is not depicted in FIG. 1B, but would typically be the same.

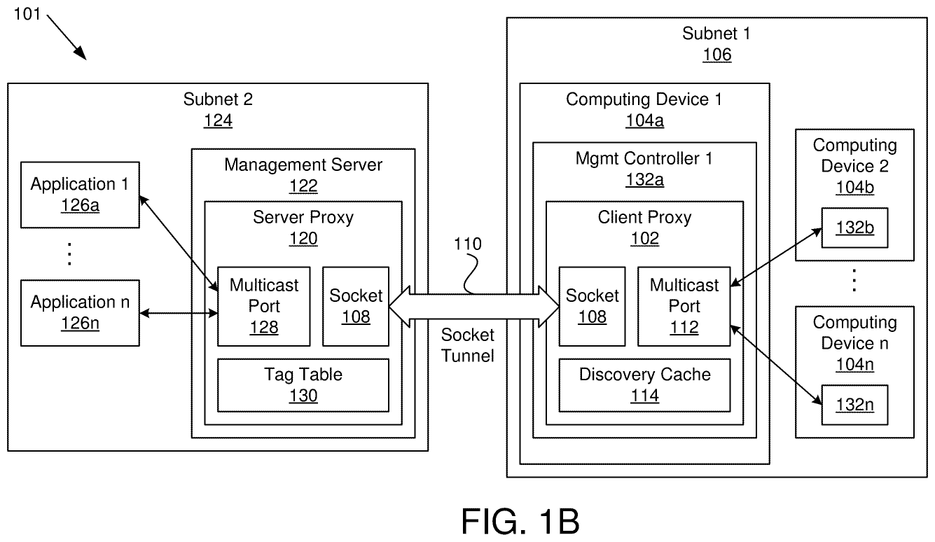

FIG. 2 a tag table 130 for tags associated with applications seeking discovery and a discovery cache table 114, according to various embodiments. The tag table 130 is intended to correspond with the tag table 130 of the systems 100, 101 of FIGS. 1A and 1B. In the tag table 130, application 1 has a tag of A0001, application 2 has a tag of A0002, etc. The tags in the tag table 130 are arbitrary and may be formatted to comply with requirements of a multicast discovery request, such as being formatted for a particular field of a header, or the like.

The discovery cache table 114 of FIG. 2 is intended to be the discovery cache 114 of the systems 100, 101 of FIGS. 1A and 1B. Device 1 would correspond to the first computing device 104a, device 2 would correspond to the second computing device 104b, etc. The information in the discovery cache column includes different discovery information for each device that would match discovery information transmitted from each of the corresponding computing devices 104. While the tag table 130 and discovery cache table 114 are depicted as simple tables, other data structures may be used.

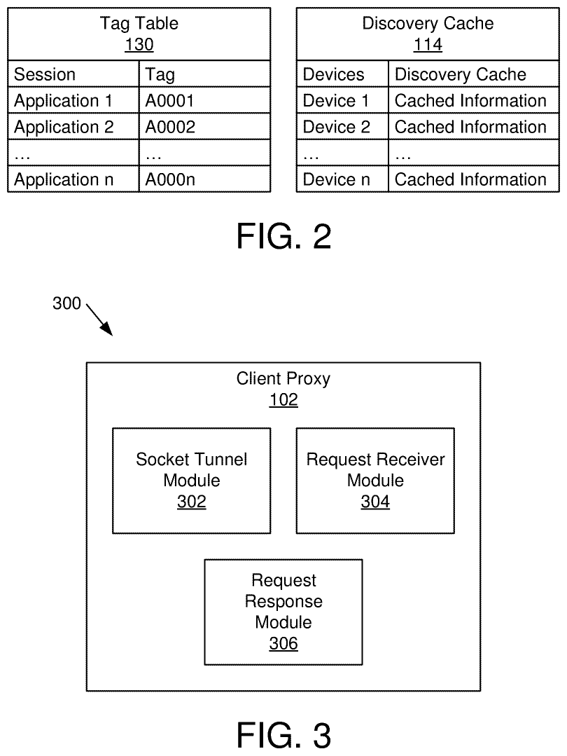

FIG. 3 is a schematic block diagram illustrating an apparatus 300 for multicast discovery requests to an isolated network, according to various embodiments. The apparatus 300 includes a client proxy 102 with a socket tunnel module 302, a request receiver module 304, and a request response module 306, which are described below. In some embodiments, the apparatus 300 is implemented with executable code where the executable code is stored on one or more computer readable storage media. In other embodiments, all or a portion of the apparatus 300 is implemented using a programmable hardware device and/or hardware circuits.

The apparatus 300 includes a socket tunnel module 302 configured to establish a socket tunnel 110 between a client proxy 102 running on a computing device 104 in a first subnet 106 and a server proxy 120 running on a server (e.g., server 122 or management server 122) on a second subnet 124. The first subnet 106 is different than the second subnet 124 so that transferring data from the second subnet 124 to the first subnet 106 typically requires traversing a firewall and/or gateway. Typically, each subnet 124, 106 include a router with a different IP address. In some embodiments, the socket tunnel 110 is a WebSocket, a transmission control protocol (“TCP”) socket, or other type of socket described above. One of skill in the art will recognize other appropriate protocols for various multicast discovery protocols. In some embodiments, the socket tunnel module 302 establishes the socket tunnel 110 by transmitting a request to the server proxy 120 and/or the server 122. In other embodiments, the socket tunnel module 302 establishes the socket tunnel 110 in response to a request from the server proxy 120.

The apparatus 300 includes a request receiver module 304 configured to receive a discovery request from the server proxy 120. The discovery request is directed to first subnet 106 computing devices 104 on the first subnet 106 and/or services provided by the first subnet 106 computing devices 104. The discovery request is transmitted over the socket tunnel 110 to the client proxy 102. In some embodiments, the discovery request complies with a multicast discovery request protocol, such as SSDP or SLP and is intended to be transmitted via a multicast to the computing devices 104. An advantage of the embodiments described herein is that the multicast discovery request can be directed to the computing devices 104 of the first subnet 106 instead of being multicast to other subnets.

The apparatus 300 includes a request response module 306 configured to transmit a discovery reply to the server proxy 120. The discovery reply includes discovery information responsive to the discovery request received from the server proxy 120. The server proxy 120 then relays the discovery reply to the application 126 that initiated the discovery request. The discovery information is regarding the first subnet computing devices 104. In some embodiments, the discovery information is present at the client proxy 102 and may have been previously stored after a previous discovery request. The discovery information may be stored in discovery cache 114 or other memory accessible to the client proxy 102. In other embodiments, the discovery information is from responses from the first subnet computing devices 104 after the discovery request is forwarded to the first subnet computing devices 104.

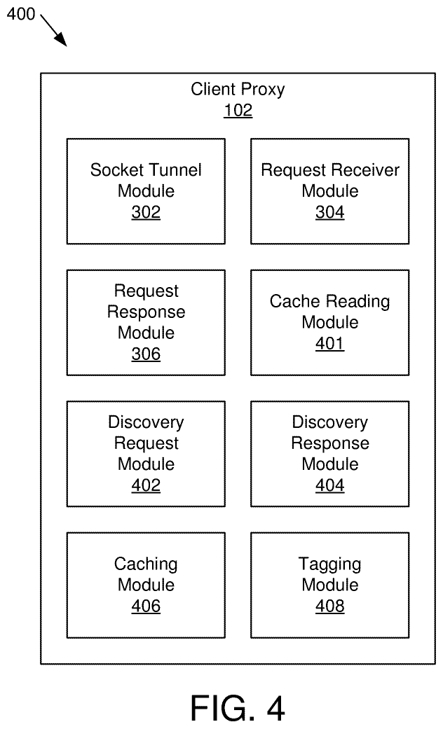

FIG. 4 is a schematic block diagram illustrating another apparatus 400 for multicast discovery requests to an isolated network, according to various embodiments. The apparatus 400 includes a client proxy 102 with a socket tunnel module 302, a request receiver module 304, and a request response module 306, which are substantially similar to those described above in relation to the apparatus 300 of FIG. 3. In various embodiments, the apparatus 400 includes a cache reading module 401, a discovery request module 402, a discovery response module 404, a caching module 406, and/or a tagging module 408, which are described below. In various embodiments, the apparatus 400 is implemented similarly to the apparatus 300 of FIG. 3.

In some embodiments, the apparatus includes a cache reading module 401 configured to read discovery cache 114 accessible to the client proxy 102 to identify discovery information regarding the first subnet 106 computing devices 104. Where the client proxy 102 has previously transmitted discovery request to the computing devices 104 and discovery information is already cached in the discovery cache 114, the cache reading module 401 reads the discovery information in the discovery cache 114. If discovery information is not present in the discovery cache 114 or is insufficient in some way, for example being in the discovery cache 114 past a time limit, the cache reading module 401 is unable to read discovery information.

In some embodiments, the apparatus 400 includes a discovery request module 402, a discovery response module 404, and a caching module 406. In response to the discovery information not being present on the discovery cache 114, the discovery request module 402 is configured to transmit the discovery request to the first subnet 106 computing devices 104, the discovery response module 404 is configured to receive discovery information from at least a portion of the first subnet 106 computing devices 104, and the caching module 406 is configured to store the received discovery information in the discovery cache 114.

In some embodiments, the discovery request module 402 transmits the multicast discovery request received from the server proxy 120 to the computing devices 104 of the first subnet 106. In some embodiments, the discovery request module 402 transmits the multicast discovery request over the multicast port 112 of the client proxy 102. Each computing device 104, including the first computing device 104a with the client proxy 102, receives the multicast discovery request and typically at least some of the computing devices 104 reply to the multicast discovery request. In some embodiments, the multicast discovery request includes instructions that cause the discovery request module 402 to transmit the multicast discovery request to only a portion of the computing devices 104 of the first subnet 106. The discovery response module 404 receives the replies from the computing devices 104 where the replies include discovery information. The discovery information from the computing devices 104 include information responsive to the multicast discovery request and may include a transport protocol, an IP address, a port number, a MAC address, or the like and may also include information about one or more services provided by the computing device 104 replying to the multicast discovery request.

In various embodiments, multicast discovery requests include a request for particular services or a request for all services provided by a computing device 104. In some embodiments, the discovery request module 402 transmits a multicast discovery request that requests information about all services provided by the computing devices 104 regardless of whether or not the multicast discovery request from the server proxy 120 includes a request for all services or for particular services. The discovery request module 402 transmitting a multicast discovery request for all services is advantageous so that each computing device 104 replies with all available services and the discovery information then stored by the caching module 406 in the discovery cache 114 is complete so that future requests may be serviced by the cache reading module 401 and request response module 306 in the client proxy 102 without the discovery request module 402 needing to send a multicast discovery request for each type of service requested in a multicast discovery request received from the server proxy 120. In other embodiments, the discovery request module 402 transmits a multicast discovery request that matches the multicast discovery request from the server proxy 120.

In some embodiments, the caching module 406 stores the received discovery information in a table or other data structure of the discovery cache 114. The discovery cache 114, in some embodiments, is modified, overwritten, etc. from time to time. In some embodiments, the cache reading module 401 determines that the discovery information in the discovery cache 114 is no longer valid for some reason and the discovery request module 402 transmits a multicast discovery request either in response to the cache reading module 401 signaling that the discovery cache 114 is invalid as part of a response to the request receiver module 304 receiving a multicast discovery request from the server proxy 120 or at another time when the cache reading module 401 determines that the discovery cache 114 is invalid.

In some embodiments, a header of the multicast discovery request includes an application tag that corresponds to an application (e.g., application 1 126a) initiating the discovery request and transmitting the discovery request to the server proxy 120. In some examples, the application tag is similar to those in the tag table 130. In such embodiments, the apparatus 400 includes a tagging module 408 configured to add the application tag of a received multicast discovery request to a discovery reply being sent by the request response module 306 prior to transmission of the discovery reply.

In some embodiments, the tagging module 408 adds the application tag to a header of the discovery reply. In other embodiments, the tagging module 408 adds the application tag to another location within the discovery reply. The server proxy 120 transmits the discovery reply to the application that sent the multicast discovery request based on the application tag. Use of application tags by the client proxy 102 and server proxy 120 provides a mechanism for transporting multicast discovery requests and response across the socket tunnel 110.

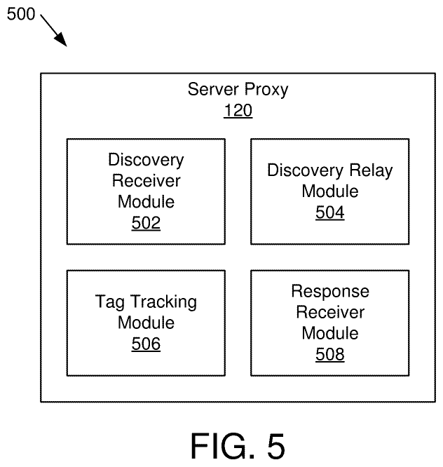

FIG. 5 is a schematic block diagram illustrating an apparatus 500 for a server proxy for multicast discovery requests to an isolated network, according to various embodiments. The apparatus 500 includes a server proxy 120 with a discovery receiver module 502, a discovery relay module 504, a tag tracking module 506, and a response receiver module 508, which are described below. In various embodiments, the apparatus 500 is implemented similar to the apparatus 300 of FIG. 3.

The apparatus 500 includes a discovery receiver module 502 configured to receive a multicast discovery request from an application 126. In some embodiments, the multicast discovery request is a general request for any applicable computing devices. In other embodiments, the multicast discovery request is targeted towards the computing devices of a particular subnet, such as the computing devices 104 of the first subnet 106. The multicast discovery request, in various embodiments, is structured based on a multicast discovery protocol, such as SSDP, SLP, or the like. In other embodiments, the discovery receiver module 502 receives a general discovery request from an application 126 and the discovery receiver module 502 and/or the server proxy 120 formats the general discovery request into a multicast discovery request of a particular protocol.

The apparatus 500 includes a discovery relay module 504 configured to transmit the multicast discovery request to the client proxy 102 of a subnet (e.g., first subnet 106) different than a subnet (e.g., second subnet 124) of the server proxy 120. In some embodiments, the discovery relay module 504 transmits the multicast discovery request over the socket tunnel 110. In some embodiments, the discovery relay module 504 formats the multicast discovery request for a protocol used by the socket tunnel 110. In some examples, the discovery relay module 504 encapsulates the multicast discovery request and adds a header suitable to transmit the multicast discovery request using the protocol of the socket tunnel 110.

The apparatus 500 includes a tag tracking module 506 configured to attach an application tag to the multicast discovery request prior to the discovery relay module 504 transmitting the multicast discovery request. In some examples, the tag tracking module 506 attaches the application tag in a header of the multicast discovery request. In some embodiments, the tag tracking module 506 creates and/or maintains a tag table, such as the tag table 130 of FIG. 2. In some embodiments, the tag tracking module 506 accesses the tag table 130 to identify an application tag associated with the application 126 (e.g., application 1 126) that initiated the multicast discovery request.

The apparatus 500 includes a response receiver module 508 configured to receive a discovery reply from the client proxy 102 over the socket tunnel 110. The discovery reply is in response to the multicast discovery request transmitted to the client proxy 102 over the socket tunnel 110. The discovery relay module 504 then relays the discovery reply to the application 126 (e.g., application 1 126a) that transmitted the associated multicast discovery request. In some embodiments, the discovery reply includes an application tag and the tag tracking module 506 accesses the tag table 130 to identify to the discovery relay module 504 the application 126 associated with the application tag of the discovery reply prior to the discovery relay module 504 relaying the discovery reply to the application 126. In some embodiments, the tag tracking module 506 removes the application tag before transmission to the application 126.

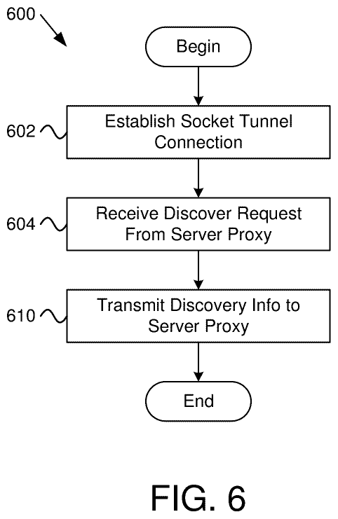

FIG. 6 is a schematic flow chart diagram illustrating a method 600 for multicast discovery requests to an isolated network, according to various embodiments. The method 600 begins and establishes 602 a socket tunnel 110 between a client proxy 102 running on a first computing device 104a in a first subnet 106 and a server proxy 120 running on a server 122 on a second subnet 124. The method 600 receives 604 a discovery request from the server proxy 120. The discovery request is directed to first subnet 106 computing devices 104 on the first subnet 106 and/or services provided by the first subnet 106 computing devices 104 and the discovery request is transmitted over the socket tunnel 110.

The method 600 transmits 606 the discovery information to the server proxy 120, and the method 600 ends. The discovery reply includes discovery information that is responsive to a discovery request received from the server proxy 120 where the discovery information is regarding the first subnet 106 computing devices 104. In various embodiments, some or all of the method 600 is implemented using the socket tunnel module 302, the request receiver module 304, and/or the request response module 306.

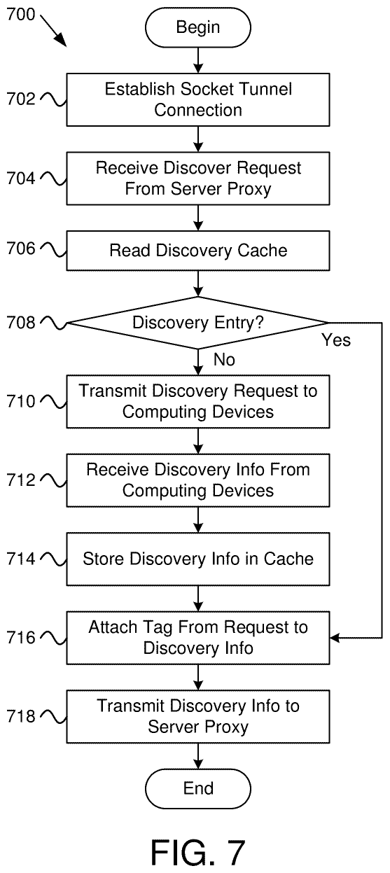

FIG. 7 is a schematic flow chart diagram illustrating another method 700 for multicast discovery requests to an isolated network, according to various embodiments. The method 700 begins and establishes 702 a socket tunnel 110 between a client proxy 102 running on a first computing device 104a in a first subnet 106 and a server proxy 120 running on a server 122 on a second subnet 124. The method 700 receives 704 a discovery request from the server proxy 120. The discovery request is directed to first subnet 106 computing devices 104 on the first subnet 106 and/or services provided by the first subnet 106 computing devices 104 and the discovery request is transmitted over the socket tunnel 110. The method 700 reads 706 discovery cache 114 accessible to the client proxy 102 to identify discovery information regarding the first subnet 106 computing devices 104. The method 700 determines 708 if there is valid discovery information in the discovery cache 114.

If the method 700 determines 708 that there is not valid discovery information in the discovery cache 114, the method 700 transmits 710 the discovery request to the first subnet 106 computing devices 104, receives 712 discovery information from at least a portion of the first subnet 106 computing devices 104, and stores 714 the received discovery information in the discovery cache 114. The method 700 attaches 716 an application tag to a discovery reply where the application tag matches an application tag attached to the received discovery request from the server proxy 120. The discovery reply includes the discovery information stored in the discovery cache 114.

If the method 700 determines 708 that there is valid discovery information in the discovery cache 114, the method 700 attaches 716 the application tag to a discovery reply where the application tag matches the application tag attached to the received discovery request from the server proxy 120. The method 700 transmits 718 the discovery reply to the server proxy 120, and the method 700 ends. In various embodiments, some or all of the method 700 is implemented using the socket tunnel module 302, the request receiver module 304, the cache reading module 401, the request response module 306, the discovery request module 402, the discovery response module 404, the caching module 406, and/or the tagging module 408.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
establishing a socket tunnel between a client proxy running on a computing device in a first subnet and a server proxy running on a server on a second subnet;
receiving a discovery request from the server proxy, the discovery request directed to first subnet computing devices on the first subnet and/or services provided by the first subnet computing devices, the discovery request transmitted over the socket tunnel; and
transmitting a discovery reply to the server proxy, the discovery reply comprising discovery information responsive to a discovery request received from the server proxy, the discovery information regarding the first subnet computing devices.

2. The method of claim 1, further comprising, in response to receiving the discovery request, reading discovery cache accessible to the client proxy to identify the discovery information regarding the first subnet computing devices, wherein transmitting the discovery reply to the server proxy is in response to identifying that the discovery information is present in the discovery cache.

3. The method of claim 2, further comprising, in response to the discovery information not being present on the discovery cache:
transmitting the discovery request to the first subnet computing devices;
receiving discovery information from at least a portion of the first subnet computing devices; and
storing the received discovery information in the discovery cache.

4. The method of claim 3, wherein the discovery request complies with a multicast discovery request protocol and/or wherein the client proxy transmits the discovery request via a multicast port.

5. The method of claim 1, wherein a header of the discovery request comprises an application tag, the application tag corresponding to an application initiating the discovery request and transmitting the discovery request to the server proxy.

6. The method of claim 5, further comprising adding the application tag to the discovery reply prior to transmission of the discovery reply, wherein the server proxy transmits the discovery reply to the application based on the application tag.

7. The method of claim 1, wherein the first subnet computing devices comprise the computing device with the client proxy.

8. The method of claim 1, wherein the server is a management server and wherein one or more of the first subnet computing devices comprise a management controller in communication with the management server.

9. The method of claim 8, wherein the client proxy executes on the management controller of the computing device with the client proxy.

10. The method of claim 1, wherein code for execution of the client proxy is installed on two or more of the first subnet computing devices and the code for the client proxy is executed on a managing computing device of the first subnet computing devices selected to manage discovery requests.

11. The method of claim 1, wherein the discovery request and the discovery reply are formulated using a multicast discovery protocol comprising one of simple service discovery protocol (“SSDP”) and service location protocol (“SLP”) and wherein the socket tunnel uses a WebSocket, a transmission control protocol (“TCP”) socket, hypertext transfer protocol (“HTTP”) socket, hypertext transfer protocol secure (“HTTPS”) socket, a user datagram protocol (“UDP”) socket, and/or a Quick UDP Internet Connections (“QUIC”) socket.

12. An apparatus comprising:
a processor; and
non-transitory computer readable storage media storing code, the code being executable by the processor to perform operations comprising:
establishing a socket tunnel between a client proxy running on a computing device in a first subnet and a server proxy running on a server on a second subnet;
receiving a discovery request from the server proxy, the discovery request directed to first subnet computing devices on the first subnet and/or services provided by the first subnet computing devices, the discovery request transmitted over the socket tunnel; and
transmitting a discovery reply to the server proxy, the discovery reply comprising discovery information responsive to a discovery request received from the server proxy, the discovery information regarding the first subnet computing devices.

13. The apparatus of claim 12, the operations further comprising, in response to receiving the discovery request, reading discovery cache accessible to the client proxy to identify the discovery information regarding the first subnet computing devices, wherein transmitting the discovery reply to the server proxy is in response to identifying that the discovery information is present in the discovery cache.

14. The apparatus of claim 13, the operations further comprising, in response to the discovery information not being present on the discovery cache:
transmitting the discovery request to the first subnet computing devices;
receiving discovery information from at least a portion of the first subnet computing devices; and
storing the received discovery information in the discovery cache.

15. The apparatus of claim 12, wherein a header of the discovery request comprises an application tag, the application tag corresponding to an application initiating the discovery request and transmitting the discovery request to the server proxy and the operations further comprise adding the application tag to the discovery reply prior to transmission of the discovery reply, wherein the server proxy transmits the discovery reply to the application based on the application tag.

16. The apparatus of claim 12, wherein the server is a management server and wherein one or more of the first subnet computing devices comprise a management controller in communication with the management server and wherein the client proxy executes on the management controller of the computing device with the client proxy.

17. The apparatus of claim 12, wherein:
the discovery request and the discovery reply are formulated using a multicast discovery protocol comprising one of simple service discovery protocol (“SSDP”) and service location protocol (“SLP”); and/or
the socket tunnel uses a WebSocket, a transmission control protocol (“TCP”) socket, hypertext transfer protocol (“HTTP”) socket, hypertext transfer protocol secure (“HTTPS”) socket, a user datagram protocol (“UDP”) socket, and/or a Quick UDP Internet Connections (“QUIC”) socket.

18. A program product comprising a non-transitory computer readable storage medium storing code, the code being configured to be executable by a processor to perform operations comprising:
establishing a socket tunnel between a client proxy running on a computing device in a first subnet and a server proxy running on a server on a second subnet;
receiving a discovery request from the server proxy, the discovery request directed to first subnet computing devices on the first subnet and/or services provided by the first subnet computing devices, the discovery request transmitted over the socket tunnel; and
transmitting a discovery reply to the server proxy, the discovery reply comprising discovery information responsive to a discovery request received from the server proxy, the discovery information regarding the first subnet computing devices.

19. The program product of claim 18, the operations further comprising, in response to receiving the discovery request, reading discovery cache accessible to the client proxy to identify the discovery information regarding the first subnet computing devices, wherein transmitting the discovery reply to the server proxy is in response to identifying that the discovery information is present in the discovery cache.

20. The program product of claim 19, the operations further comprising, in response to the discovery information not being present on the discovery cache:
transmitting the discovery request to the first subnet computing devices;
receiving discovery information from at least a portion of the first subnet computing devices; and
storing the received discovery information in the discovery cache,
wherein a header of the discovery request comprises an application tag, the application tag corresponding to an application initiating the discovery request and transmitting the discovery request to the server proxy and the operations further comprise adding the application tag to the discovery reply prior to transmission of the discovery reply, wherein the server proxy transmits the discovery reply to the application based on the application tag.
